(19) United States
(12) Patent Application Publication
(10) Pub. No.: US 2026/0025348 A1
(43) Pub. Date: Jan. 22, 2026

(54) Audio-based social media platform

(71) Applicant: BRAGI GmbH, München (DE)

(72) Inventor: Nikolaj Hviid, München (DE)

(73) Assignee: BRAGI GmbH, München (DE)

(21) Appl. No.: 19/342,479

(22) Filed: Sep. 26, 2025

Related U.S. Application Data
(63) Continuation of application No. 18/626,175, filed on Apr. 3, 2024, now Pat. No. 12,463,926.
Application No. 18/626,175 is a continuation of application No. 18/296,885, filed on Apr. 6, 2023, now Pat. No. 11,956,191.
Application No. 18/296,885 is a continuation of application No. 17/677,597, filed on Feb. 22, 2022, now Pat. No. 11,627,105.
Application No. 17/677,597 is a continuation of application No. 15/716,204, filed on Sep. 26, 2017, now Pat. No. 11,283,742.
(60) Provisional application No. 62/400,391, filed on Sep. 27, 2016.

(51) Int. Cl. H04L 51/10; G06F 3/16; H04L 51/212; H04L 51/222; H04L 51/42; H04L 51/52; H04R 1/10

(52) U.S. Cl. CPC H04L 51/10; G06F 3/167; H04L 51/52; H04R 1/1016; H04L 51/212; H04L 51/222; H04L 51/42; H04R 2225/55; H04R 2420/07

(57) ABSTRACT

A method for audio-based social media messaging for a wearable device includes generating a first audio message using a wearable device, the wearable device having at least one microphone and at least one speaker and conveying the first audio message from the wearable device to an audio-based social media platform using a wireless radio transceiver within the wearable device.

### PRIORITY STATEMENT

This application is a continuation of U.S. Non-provisional patent application Ser. No. 18/626,175, filed Apr. 3, 2024, which is a continuation of U.S. Non-provisional patent application Ser. No. 18/296,885, filed Apr. 6, 2023 now U.S. Pat. No. 11,956,191, which is a continuation of U.S. Non-provisional patent application Ser. No. 17/677,597, filed Feb. 22, 2022 now U.S. Pat. No. 11,627,105, which is a continuation of U.S. Non-provisional patent application Ser. No. 15/716,204, filed on Sep. 26, 2017 now U.S. Pat. No. 11,283,742, which claims priority to U.S. Provisional Patent Application 62/400,391, filed on Sep. 27, 2016, all entitled “Audio-based social media platform”, hereby incorporated by reference in their entirety.

### FIELD OF THE INVENTION

The present invention relates to audio-based social media communication using wearable devices. More particularly, but not exclusively, the present invention relates to an audio-based social media platform.

### BACKGROUND

Social media provides users with a computer-mediated tool to create, share, and exchange information. Computer-mediated tools such as Facebook chats, Instagram posts, LinkedIn, and text messaging all necessitate the use of a screen for the exchange of information. Teenagers in the United States spend about nine hours per day in front of a screen. Therefore, what is needed is a new form of communication with a completely screen free messenger interface.

### SUMMARY

Therefore, it is a primary object, feature, or advantage of the present invention to improve over the state of the art.

It is a further object, feature, or advantage of the present invention to provide enhanced auditory communication using wearable devices.

It is a still further object, feature, or advantage of the present invention to provide users with a social media network of people using audio-based communication.

Another object, feature, or advantage is to interact with others without the need to use keyboards or screens.

It is still a further object, feature, or advantage of the present invention to provide the user with a means of sending audio-based communication via a gesture.

It is another object, feature, or advantage of the present invention to provide an individual with the ability to share audio messaging with an individual person, a group of people, or even strangers.

Yet another object, feature, or advantage of the present invention is to associate an audio message with a particular location.

A further object, feature, or advantage of the present invention is to provide for a social media experience that emulates real life.

A still further object, feature, or advantage is to allow for personal and immediate communications between people.

Another object, feature, or advantage is to allow for a social media experience that promotes conversational interaction and authentic interactions.

Yet another object, feature, or advantage is to provide for a social media experience, which may be used for purely social or business related interactions including those, which promote customer engagement.

A further object, feature, or advantage is to provide for a social media experience which need not result in interactions being permanent and allows for interactions which are private.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

According to one aspect, a method for audio-based social media messaging for a wearable device includes generating a first audio message using a wearable device, the wearable device having at least one microphone and at least one speaker and conveying the first audio message from the wearable device to an audio-based social media platform using a wireless radio transceiver within the wearable device. The method may further include generating social media data associated with the first audio message at the wearable device and conveying the social media data to the audio-based social media platform using the wireless radio transceiver within the wearable device. The social media data may include delivery data indicating one or more users on the social media platform to receive the first audio message, a location associated with where the first audio message is generated or where the wearable device is located when the audio message is sent. The method may further include receiving a notification from the wearable device that a second audio message is available. The method may further include playing the second audio message using the wearable device.

According to another aspect, a wearable device configured to support an audio-based social media network. The wearable device may include a wearable device housing, at least one speaker associated with the wearable device housing, at least one microphone associated with the wearable device housing and a wireless transceiver disposed within the wearable device housing. The wearable device may be configured to connect to the audio-based social media network through the wireless transceiver to send and receive audio messages.

According to another aspect, a method for providing audio-based social media messaging to a plurality of wearable devices, each of the wearable device having a speaker and a microphone includes steps of receiving audio messages and audio message identification and delivery data from the plurality of wearable devices, storing the audio messages and the audio message identification and delivery data on a server platform, and delivering one or more of the audio messages to one or more of the plurality of wearable devices based on the audio message identification and the delivery data.

According to another aspect, a method for audio-based social media messaging for a wearable device is provided. The method includes generating a first audio message using a first wearable device, the first wearable device having at least one microphone and at least one speaker and no screen display, and sending the first audio message from the first wearable device over a network to an audio-based social media server platform using a wireless radio transceiver within the first wearable device. The method may further include storing the first audio message on the audio-based social media server platform for a time period, and communicating the first audio message on the audio-based social media server platform to a second wearable device, the second wearable device having at least one microphone and at least one speaker and no screen display. The method may further include generating social media data associated with the first audio message at the first wearable device and conveying the social media data to the audio-based social media platform using the wireless radio transceiver within the first wearable device.

### BRIEF DESCRIPTION OF THE DRAWINGS

Illustrated embodiments of the disclosure are described in detail below with reference to the attached drawing figures, which are incorporated by reference herein.

FIG. 1 is a pictorial representation depicting one example of wearable devices interacting with an audio-based social media platform.

FIG. 2 illustrates an example of a bubble which multiple users and their associated wearable devices are a part of.

FIG. 3 illustrates a wearable device and a series of bubbles being generated by or received at the wearable device.

FIG. 4 illustrates a bubble being popped.

FIG. 5 illustrates a bubble with a series of audio messages contained therein.

FIG. 6 illustrates a bubble anchored to a particular location.

FIG. 7 illustrates a block diagram of one example of a wearable device.

### DETAILED DESCRIPTION

The present invention relates to an audio-based social media messaging platform or experience and related systems and methods. Current social media applications generally provide users with a screen-based method of sharing information that focuses on typing and reading information. These social media sites are limited in the manner and location in which the user may communicate information. Users must be in places they can type out a message, and have their electronic devices with them. One of the criticisms of such social media usage is that users can miss experiencing life around them because of their fixation on a display. Another problem relates to safety. If users stare at screens while they walk, drive, or engage in other activities, the users put themselves and/or others in danger. Therefore an audio-based social media messaging platform as shown and described herein allows for removing the need to rely on a display and promotes more natural social media communications. Thus, chats may occur without keyboards or screens and while a user is otherwise interacting with their environment. The term “bubble” is sometimes used herein when referring to aspects of the invention. As used herein, a “bubble” is associated with an audio message that may have a particular reach. It may include the content of one or more audio messages as well as convey inclusiveness or reach (e.g. bubbles may grow such as to include others or add to the messaging) and may also convey a temporary nature of the communication (e.g. a bubble may be popped).

To trigger the audio-based social media application or functionality, a gesture may be used. The gesture may be used as input to a wearable device such as an earpiece having one or more microphones. Once triggered or activated an audio message or bubble may be sent by simply speaking. The audio message or bubble may be of different types and have different delivery options associated with it. For examples, a user may send an audio message in the form of a bubble to other users in their social media network or group or sub-group within their social media network or list of contacts within the social media network. Alternatively, the user may send an audio message or bubble to a single recipient. A user may also make the bubble “fly” and allow the bubble to be shared with other users of the audio-based social media platform who are not within the list of contacts associated with the user. Alternatively, a user may “stick” the audio message or bubble to a particular location (such as a geolocation associated with the user's current location or other location) so that other users may only hear the audio message or join the bubble when present at the location.

A list may be maintained locally and/or on a server associated with the audio-based social media platform. The list may include a plurality of different contacts associated with a user. It is contemplated that a user may build this list or add to it individually. In addition, or alternatively, the audio-based social medial platform may scan any number of different social media channels associated with a user in order to add contacts into this list. This may include email contacts, social media contacts, or other types of contacts. A user may invite someone to message or join a bubble in one tap or less.

In addition, artificial intelligence may be used to generate an audio message around a user so that the user does not feel alone and to make the social media platform a more inclusive and positive experience for all users. The audio message may relate to the location of the user, the environment of the user, or otherwise be of interest to the user. For example, the audio message may contain good news or interesting information. In addition, a user may create a bubble which is directed to an artificial intelligence system and the response may then be a part of a bubble.

There are numerous different types of messages. For example, family members may leave messages for one another. Thus, for example, a mother could create a bubble stating, “There is some lasagna in the fridge just heat it up, mom.” The mother could share this directly to one or more children. Alternatively, the mother could attach this to a location at or near the refrigerator or within the kitchen so that the bubble would be available at an appropriate when the children are in the kitchen. This example is an example of an indoor bubble.

Similarly, a bubble may be attached to an outdoor location. For example, a bubble may be attached to location that states “from here you have the best view on the bay bridge.” Thus, when individuals open to receive messages are at the location they can hear the message of this bubble and that promotes active engagement with their environment.

A bubble may also be epic in nature. For example, a bubble may be sent which states “around cape canaveral you can find a lot of bubbles from Neil Armstrong bubbling about Apollo 11.” Of course, bubbles may be otherwise epic in nature depending upon their content or environment.

A bubble may also be a service bubble. For example, a restaurant guidebook, online review site, or other service provider may leave a message associated with a restaurant such as, “In this lovely restaurant everything is good. Try the red thai curry their most famous dish.” Thus, a person may have information available to them in the form of a bubble at the place and time of need.

In addition, messages may be created with artificial intelligence or which are directed to artificial intelligence may be created. For example, a messages of “I wonder where there is the next good indian place?” may be created or the message “Where is the next good indian place?” and these messages may be directed towards an artificial intelligence system for responding such as by selecting a pre-existing bubble (e.g. a service bubble previously created) or creating a response to add to a bubble.

Group bubbles is another type of bubble that may be set. For example, a bubble may be sent to or shared with a plurality of recipients that states, “Let's create a Saturday barbeque bubble!.” Once created, messaging associated that event may be associated with the bubble.

A live bubble may be sent such as “Let's link with BUBBLE!” thereby inviting one or more additional individuals to communicate with one another using the platform.

A “spread bubble” such as “Random Jokes & Wisdom” may be sent. The spread bubble may be used to collect messages from any number of different users and such a bubble will grow over time.

A “love bubble” such as “seeking a good night, male 28” may be sent. This type of bubble may be sent to recipients open to receiving this type of bubble.

It is to be understood that the above examples of different types of bubbles is not limiting and that any number of different types of bubbles are contemplated based on the content of the bubble, the manner in which the bubble is to be disseminated, the location of the bubble, the recipient(s) of the bubble, the source of the bubble, or otherwise.

It is further contemplated that bubbles may be popped. Thus, unlike certain forms of social media contents of bubbles need not be public nor permanent but may be flecting and ephemeral. Once popped a bubble may simply cease to exist no longer stored anywhere or accessible by anyone. Alternatively, once popped the bubble may be temporarily stored and marked for delction according to a bubble retention policy or based on user preferences with the possibility of restoring the bubble such as if the bubble was inadvertently or prematurely popped. It is contemplated that different rules may be implemented regarding who has permission or authority to pop a bubble. For example, anyone who creates the bubble may pop it, anyone who receives the bubble may pop it, only the creator may pop it, only the receiver may pop it, if it is a group bubble only the creator may pop it, the bubble may automatically pop after a set time period or on a certain time and date, after a certain number of listens, or any number of different rules may be applied. Note that the rules may be based in whole or in part on user preferences and that different rules may apply for different types of bubbles. For example, a service bubble may pop after it has been listened to a set number of times if a service provider only pays for a set number of listens. It is also contemplated that meta data about a bubble may also potentially be maintained after a bubble has been popped such as information about who was a part of the bubble or other information which does not include the actual audio message. It is also contemplated that some types of bubbles may be effectively permanent in nature where desired.

The ability to pop a bubble may be advantageous in a number of different situations and for a variety of different reasons. For example, the ability to pop a bubble allows for interactions between individuals to be temporary in nature and not permanent and potentially public. Therefore the use of bubbles may serve to better emulate real life person-to-person conversations and be more authentic. This may also be more advantageous for customer engagement as well such as interactions between an individual and customer support or other types of business interactions where it is helpful to promote authenticity and allow for conversational interaction.

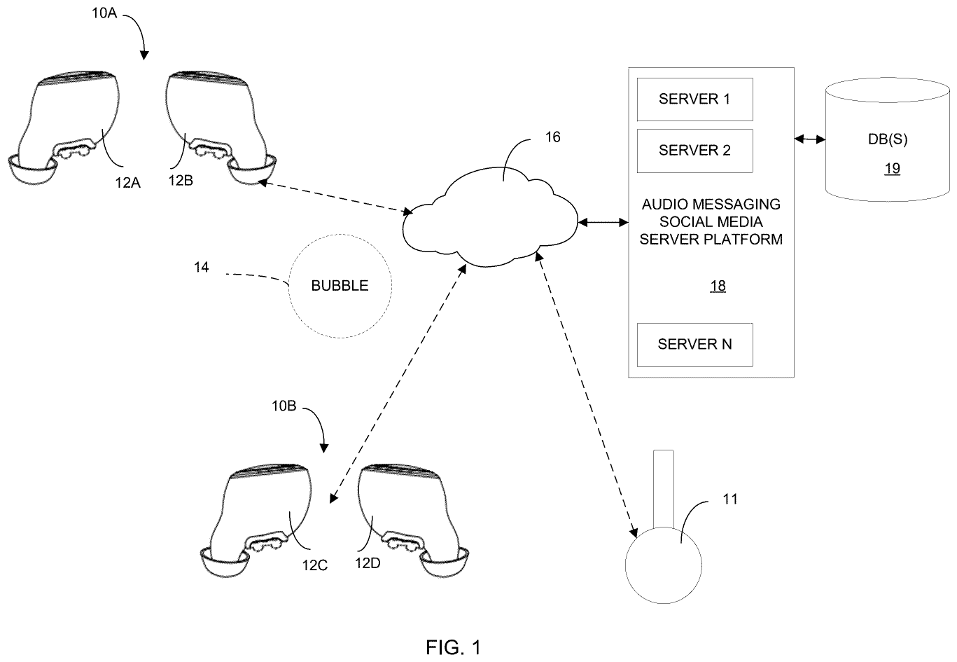

FIG. 1 illustrates one example of a system that includes an audio-based social media platform. As shown in FIG. 1 a first wearable device or system 10A in the form of one or more earpieces 12A, 12B may create an audio message as part of a new or existing bubble, wherein a second wearable device or system 10B in the form of one or more earpieces 12C, 12D is also a part of the bubble 14 or otherwise has access to or interacts with the bubble 14. Alternatively, other types of wearables may be used including over-the-ear ear phones 11. The audio message and related data such as delivery data or meta data about the bubble may be communicated over a network to an audio messaging social media server platform. The audio messaging social media server platform 18 may include one or more servers which may be hardware based or virtual servers. Where multiple servers are present load balancing may be provided. The server platform 18 is in operative communication with one or more databases 19 or other data storage which may store audio messages and related data including delivery data such as identification of others within the bubble, a location or geolocation to which the bubble is tethered, a time at which the message is to be delivered, or other information.

The servers may provide for any number of different functions. For example, the servers may be configured to filter the messages from the bubble. Thus, if audio messages are negative or inappropriate based on policies of the social media platform, or according to user preferences, the audio messages may be deleted or returned to the sender with the sender being notified that the message will not be permitted within a bubble. Such content filtering allows for the social media platform which promotes positive communications.

Note that the wearable devices 10A, 10B may access the network 16 in any number of ways depending upon their hardware configuration. For example, the wearable devices may include Bluetooth or Bluetooth wireless transceivers which communicate with mobile devices (not shown) such as phones or tablets which then access the network through a cellular transceiver or Wi-Fi transceiver. Alternatively, the wearable devices may include a cellular transceiver of Wi-Fi transceiver, or the network may be otherwise accessed.

Although the wearable devices shown are in the form of earpieces which may be ear bud earpieces or over-the-ear earphones or other form factors, other types of wearable devices may be used such as articles of clothing, jewelry items, watches, eye glass(es), or other wearable devices. In addition, note that no screen displays are required for the wearable devices because the social media network is audio messaging social media platform. Thus, the audio messages may be sent, received, stored, shared, deleted, or other actions may be taken without use of a screen display by a user.

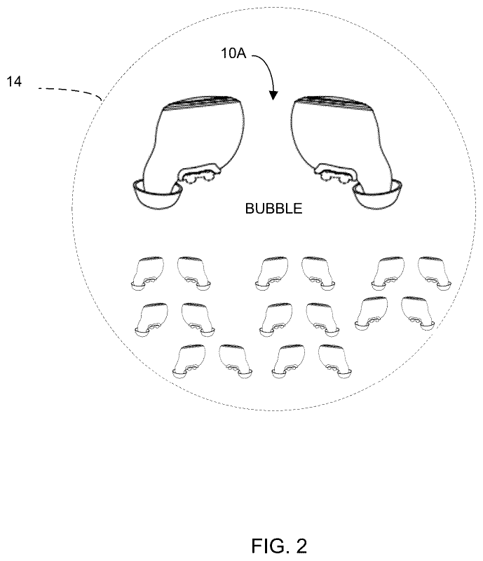

FIG. 2 illustrates one example of a bubble 14. As shown in FIG. 2, multiple different users and/or their associated wearable devices may be a part of a bubble. Being a part of a bubble includes the ability to access audio messages associated with a bubble and/or create audio messages associated with bubble, or otherwise control the bubble 14.

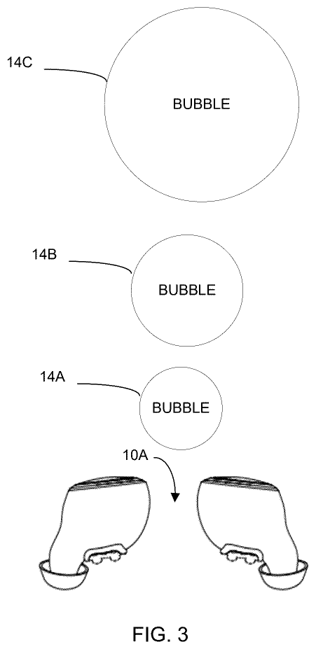

FIG. 3 illustrates another example of a series of bubbles 14A, 14B, 14C associated with a wearable device 10A. A user may create a bubble 14A, 14B, 14C or join a bubble or otherwise use a bubble for sending or receiving communications.

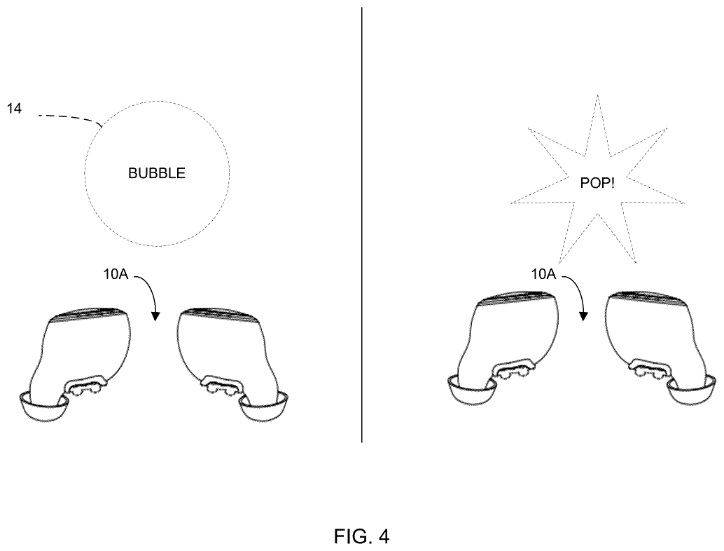

FIG. 4 illustrates a wearable device 10A and a bubble 14 and further illustrates that a user may choose to pop the bubble 14. Upon the popping of a bubble 14, the contents may no longer be available to the users or others who had access to the contents of the bubble 14. Thus, for example, if the bubble 14 included a plurality of audio messages, the audio messages would no longer be available in the normal course of usage.

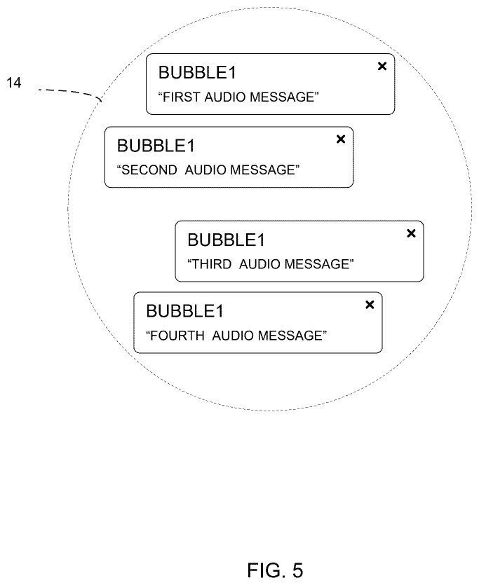

FIG. 5 illustrates an example of a bubble 14 which includes a plurality of different audio messages between persons “within” the bubble 14. When the conversation is complete the bubble can be popped.

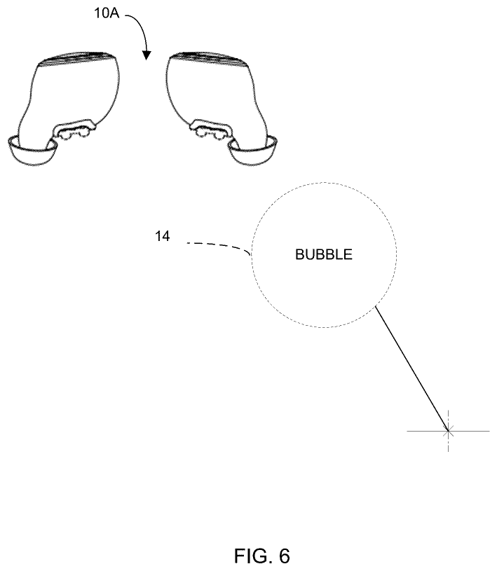

FIG. 6 illustrates one example of interacting with a bubble which is anchored to a particular location or geolocation. Thus, in one embodiment, a user only accesses an audio message associated with that bubble when the user is present at that location or in very near proximity thereto. Similarly, while at a particular location, a user may create a bubble and anchor it to that location. A user may also be able to create bubbles for particular locations even when they are not physically present at that location. The locations may be geolocations or may be other relative locations. For example, a location may be anchored to a vehicle or other device.

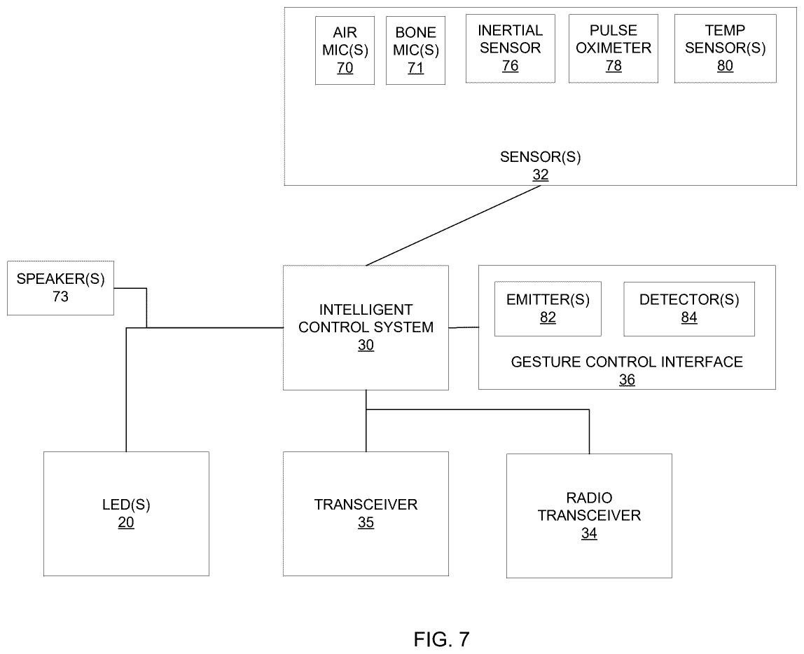

FIG. 7 illustrates one example of an earpiece which may be used. Where more than one earpiece is used as a part of a wearable device certain functionality may exist in only the right earpiece or only the left earpiece and need not be present in both earpieces. For example, health monitoring sensors need only be present in one of the earpieces. As shown in FIG. 6, an intelligent control system 30 is shown which may include one or more processors. Sensors 32 may be operatively connected to the intelligent control system 30. Any number of different sensors may be used including air microphones 70, bone microphones 71, one or more inertial sensors 76, a pulse oximeter 78, and one or more temperature sensors 80. One or more speakers 73 may be present. The one or more microphones 70, 71 may be used for sensing voice sound communications from a user such as audio messages for including within a bubble. The one or more speakers 73 may be used for generating sound such as one or more audio messages from within a bubble. A gesture control interface 36 is shown which is operatively connected to the intelligent control system 30. The gesture control interface may include one or more emitters 82 and one or more detectors 84 which may be used for sensing gestures such as taps, double taps, triple taps, tap and holds, swipes, or other gestures. One or more LEDs may be present which are operatively connected to the intelligent control system 30. One or more transceivers may also be present such as a radio transceiver 34 which may be a BLUETOOTH or BLE transceiver or Wi-Fi transceiver, or cellular transceiver and a transceiver 35 which may be a near field magnetic induction transceiver. Of course, other types of transceivers may be used.

As shown in FIG. 7, various types of sensors may be present in the wearable device or in operative communication with or networked to the wearable device. Data from one or more sensors may be used to create or add to a bubble. The wearable sensors may be used to read user biometrics, including but not limited to pulse rate, blood pressure, blood oxygenation, temperature, calories expended, blood or sweat chemical content, voice and audio input, impact levels, and orientation (e.g., body, head, etc.). The wearable sensors may also determine the user's location, position, velocity, impact levels, and so forth. In some embodiments, the wearable device or the audio-based social media platform may create audio messages from data sensed by the wearable device. For example, the wearable device may track distance run, distance swam, distance biked, or related information. Periodic or milestone event measurements may be communicated to others who are a part of a bubble. For example, a marathon training group may receive messages from the wearable devices of others within the group regarding the activity of their fellow group members. Thus, group members can then add to the bubble by commenting with their own audio messages such as congratulatory messages or words of praise or encouragement. Note that the person performing the activity can continue to perform the activity and still access the audio message. Similarly, a weight loss group could communicate with one another after a wearable device communicates estimated calories expended or exercise performed by a group member. These examples further illustrate some of the benefits of an audio-based social media platform which allows individuals to participate in social media while also actively engaged in activities and doing so in a natural manner.

If a user is not available to hear the BUBBLE, the BUBBLE may be stored until the user can access it and listen to it. A wearable device allows the user to operate in a hands-free situation. Since the messages sent are spoken by the user instead of being typed, the user has the option to send, receive, and manage the BUBBLES in more convenient locations, such as while walking or driving or otherwise actively engaged in other activities.

It is to also be understood that the audio-based social media platform may maintain databases of its own users, or it may interact with another social network to reach more users. Other social networks include but are not limited to, FACEBOOK, FACEBOOK MESSENGER, GOOGLE, GOOGLE+, SNAPCHAT, LINKEDIN, YOUTUBE, VIBER, TUMBLR, TWITTER, BAIDU TIEBA, PINTEREST, INSTAGRAM, WHATSAPP or others. The audio-based social media platform may interact with other social media services in various manners. For example, a user's contacts on various different social media platforms may be integrated into a list of contacts on the audio-based social media platform. In addition, various other social media platforms may integrate with the audio based social media platform in one manner or another. For example, a user may select to have other types of social media messages converted into bubbles.

Preferably each BUBBLE contains good news or interesting stuff. Because of filtering that may be performed using artificial intelligence to delete hateful messages or otherwise negative or inappropriate messages, users will be encouraged to leave messages which feel playful and good.

The invention is not to be limited to the particular embodiments described herein. In particular, the invention contemplates numerous variations in the server platform used, the manner in which messages are conveyed, the manner in which messages are created, the manner in which messages are delivered, and other variations. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes or methods of the invention. It is understood that any other modifications, substitutions, and/or additions can be made, which are within the intended spirit and scope of the invention.

What is claimed is:

1. A method for audio-based social media messaging for a wearable device, the method comprising:
using artificial intelligence to generate a first audio message using a wearable device, the wearable device having at least one microphone and at least one speaker operatively connected to a processor within the wearable device;
associating the first audio message with a bubble;
anchoring the bubble to a particular anchor location;
sending the first audio message from the first wearable device over a network to an audio-based social media server platform using a wireless radio transceiver operatively connected to the processor within the wearable device;
storing the first audio message on the audio-based social media server platform for delivery based on the particular anchor location associated with the bubble;
communicating the first audio message on the audio-based social media server platform, after receiving information evidencing the second wearable device is in proximity to the particular anchor location, to a second wearable device having at least one microphone and at least one speaker;
receiving a second audio message at the first wearable device from a second user of the second wearable device;
associating the second audio message with the bubble; and
playing the second audio message using the first wearable device.

2. The method of claim 1, wherein the artificial intelligence generates the first audio message to prevent a user from feeling alone.

3. The method of claim 1, wherein using artificial intelligence to generate the first audio message comprises generating audio content based on user location data.

4. The method of claim 1, wherein using artificial intelligence to generate the first audio message comprises generating audio content based on environmental context surrounding the user.

5. The method of claim 1, wherein the artificial intelligence generates the first audio message automatically without requiring user input to initiate message creation.

6. The method of claim 1, wherein using artificial intelligence to generate the first audio message comprises selecting from pre-generated audio content based on current user context.

7. The method of claim 1, wherein the wearable device comprises eye glasses.

8. The method of claim 1, wherein the wearable device comprises jewelry items.

9. The method of claim 1, wherein the wearable device comprises a watch.

10. The method of claim 1, wherein the first wearable device comprises biometric sensors, and wherein using artificial intelligence to generate the first audio message is based on biometric data from the biometric sensors.

11. The method of claim 1, wherein using artificial intelligence to generate the first audio message comprises generating audio content responsive to detected user emotional state.

12. The method of claim 1, wherein the artificial intelligence generates the first audio message to initiate social interaction for the user.

13. The method of claim 1, wherein using artificial intelligence to generate the first audio message comprises generating contextually relevant audio content based on the particular anchor location.

14. The method of claim 1, wherein the artificial intelligence generates multiple audio message options and selects one based on user preferences.

15. The method of claim 1, wherein using artificial intelligence to generate the first audio message comprises generating audio content that encourages positive social interaction.

16. A method for social media messaging for a wearable device, the method comprising:
using artificial intelligence to generate a first message using a wearable device, the wearable device having at least one microphone and at least one speaker operatively connected to a processor within the wearable device, and a gestural control interface;
associating the first message with a bubble;
anchoring the bubble to a particular anchor location;
sending the first message from the first wearable device over a network to a social media server platform using a wireless radio transceiver operatively connected to the processor within the wearable device;
storing the first message on the audio-based social media server platform for delivery based on the particular anchor location associated with the bubble;
communicating the first message on the social media server platform, after receiving information evidencing the second wearable device is in proximity to the particular anchor location, to a second wearable device having at least one microphone and at least one speaker, and a gestural control interface;
receiving a second message at the first wearable device from a second user of the second wearable device;
associating the second message with the bubble; and
outputting the second message using the first wearable device.

17. The method of claim 16, wherein the artificial intelligence generates the first message to prevent a user from feeling alone.

18. The method of claim 16, wherein using artificial intelligence to generate the first message comprises generating content based on user location data.

19. The method of claim 16 wherein the wearable device comprises an earpiece.

20. The method of claim 16 wherein the wearable device comprises eye glasses.
